(19) United States
(12) Patent Application Publication
(10) Pub. No.: US 2016/0138213 A1
(43) Pub. Date: May 19, 2016

(54) COMPOSITE FRICTION MATERIALS

(71) Applicants: David N. Bortz, Warrensville Hts., OH (US); Brian C. Howells, Lakewood, OH (US); Erik M. Tobin, Chagrin Falls, OH (US)

(72) Inventors: David N. Bortz, Warrensville Hts., OH (US); Brian C. Howells, Lakewood, OH (US); Erik M. Tobin, Chagrin Falls, OH (US)

(21) Appl. No.: 14/854,778

(22) Filed: Sep. 15, 2015

Related U.S. Application Data
(63) Continuation-in-part of application No. PCT/US2014/028452, filed on Mar. 14, 2014.

(51) Int. Cl. D06M 11/77; F16D 13/64; F16D 69/02; D06M 11/74; D06M 15/59

(52) U.S. Cl. CPC D06M 11/77; D06M 11/74; D06M 15/59; F16D 69/02; F16D 13/64; D06M 2200/35; D06M 2200/30; D06M 2101/36

(57) ABSTRACT

A textile-reinforced composite friction material is provided by the present invention that includes a nonwoven needlepunched fiber mat, a resin matrix impregnated within and onto the fiber mat, and an inorganic nanomaterial such as a carbide nanomaterial dispersed within the resin matrix. The carbide nanomaterial is preferably tungsten, silicon or titanium carbide nanomaterial.

### Related Applications

This application is a continuation-in part of International Application No. PCT/US2014/028452, filed Mar. 14, 2014, which claims priority to U.S. Provisional Application No. 61/787,666, filed Mar. 15, 2013, the entirety of these applications are incorporated herein by reference.

### Technical Field

The present invention relates generally to friction materials, and more specifically to non-woven needlepunched textile-reinforced polymer composite friction materials and more specifically to nanomaterial enhanced friction materials and friction products.

### BACKGROUND OF THE INVENTION

Friction products having nonwoven needlepunched textile-reinforced composite (NNTRC) materials have demonstrated effective performance in a variety of applications. NNTRCs have facilitated the incorporation of fibers and binder matrix resins in composites that previously were not commonly used. Their fibrous structures and resulting friction properties are unique to friction and demonstrate heat transfer through a composite open porosity which is mainly composed of the fiber and resin. In some applications, the NNTRC's replace nonwoven wetlaid materials such as paper.

Known powdered and particulate fillers, while being claimed as used in up to 40% by weight of the composite, (a level at which fillers would have a noticeable influence over the mechanical properties and character of the whole composite), have not yet been commercially successful or readily incorporated into NNTRC products in greater than about 3% by weight. These fillers are meant to “fill” rather than affect the composite, and have to date only made minor contributions to properties, performance, and reduced cost. Additionally, specification of the fillers on a weight basis, as is the convention, ignores the consideration of the particle in the area of the critical friction surface as it rubs an opposing surface, as friction properties are a function of the population and volume of particles actually engaged in friction. Moreover, especially at higher loadings of filler, the bulk composite porosity is influenced.

U.S. Pat. Nos. 5,646,076 and 5,989,375 disclose prior art wear resistant devices and method of their manufacture and are hereby incorporated by reference.

U.S. Pat. No. 7,429,418, discloses a porous friction material comprising nano particles of friction modifying material and is hereby incorporated by reference

Another example of composite friction material is disclosed in U.S. Patent Publication No. 2008/0176470 A1, which is hereby incorporated by reference.

### SUMMARY OF THE INVENTION

In one preferred form, the present invention includes a composite coated textile friction material comprising a needlepunched fiber mat resulting from one or more layers of fibrous batts being needlepunched together, a resin coating matrix impregnated in the fiber mat and a dispersion of nanoparticles through the matrix and coating the fibers. The nanomaterials are inorganic and preferably selected from groups such as carbides of silicon, tungsten, titanium and the like.

In another form, the present invention includes a part for use in a friction application comprising a backing substrate and a friction facing element attached to the substrate, wherein the friction element comprises an NNTRC with nanomaterial dispersed within and together attached to a carrier backing substrate. The part may include by way of example, a brake or clutch plate, a transmission friction disc or band, a torque converter or slip differential friction element, a synchronizer friction element, and a brake pad, block or shoe, among others.

In yet another form, the present invention includes a composite material for use in friction applications comprising one or more nanomaterials selected from the groups consisting of: carbides of silicon, tungsten, titanium and the like. The inorganic hard and heat resistant nanomaterials, are dispersed through the resin matrix and coating the fibrous textile mat.

In another form, the present invention includes a composite material for improved use in friction materials. Said improvement being increased coefficients of friction and/or increased heat and/or increased wear resistance.

According to one illustrated embodiment, an improved composite friction material for use in friction applications is disclosed. The improved material comprises a non-woven needlepunched fiber mat of staple fibers; a resin matrix impregnated in the fiber mats; and a carbide nanomaterial dispersed within the composite.

The carbide nanomaterial is preferably selected from the group consisting of tungsten, titanium and silicon and in the preferred embodiment, the carbide nanomaterial comprises between approximately 2 and 20% of the composite material by weight. It has been found that the improved composite material of the invention has an increased dynamic coefficient of friction and increased fade resistance.

In another preferred embodiment, the fiber mat of staple fibers is needlepunched to a density of 1000-7000 penetrations per cm³. This needle density achieves the desired material integrity and open connected pore structure preferable for both dry and wet friction applications and cannot be achieved by other methods. In addition, one preferred embodiment includes staple fibers that are selected from a group consisting of aramid, glass, ceramic and carbon fibers.

A friction product that uses the improved composite friction material includes a backing or backing plate and the improved composite friction material is bonded thereto. The friction product may include, but not limited to, a brake plate, a clutch plate, a transmission band, a brake band, a torque converter lining, a slip differential or synchronizer friction element and a brake pad or block. The backing support member to which the frictional material is attached is preferably metal. The improved composite friction material of the invention may be formed as a lining or facing and may be a stand-alone component unattached to a support or plate.

According to the invention, a method of forming an improved composite friction material is disclosed and includes the steps of preparing the fiber mat, dispersing a carbide nanomaterial within a resin using a slurry of the nanomaterial and a solvent, saturating the fiber mat with resin containing the nanomaterial, drying, curing and densifying the composite material and combining the so-treated composite with a backing member. In a preferred embodiment, the staple fibers comprise approximately 20-80% of the weight of the composite material. The resin may also comprise approximately 20-80% by weight of the composite with the balance of the resulting composite being carbide nanomaterials. The nanomaterials preferably comprise approximately 2 to 20% by weight of the composite, the actual percentage being determined by the amount of staple fibers and resin used. In a more preferred embodiment, the fibers of the composite are mechanically entangled and are the result of needlepunching one or more carded fiber batts together on the order of 2500 to 35000 needle penetrations per cm³ of the resulting friction material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying photomicrographs and drawings, wherein:

FIG. 1 is a cross-sectional view of a nonwoven needlepunched textile-reinforced polymer composite material having carbide nanomaterials dispersed therein in accordance with the principles of the present invention and showing necessary porosity for effective lubricating fluid flow in a wet friction material;

FIG. 2 is a perspective view of a part for use in a friction application and constructed in accordance with the principles of the present invention;

FIG. 3 is a process flow diagram illustrating a method of processing a nonwoven needlepunched textile-reinforced polymer composite material having carbide nanomaterials dispersed therein in accordance with the principles of the present invention and showing the step of compression in which density of the composite is adjusted to approximately 20 to 70% by volume and providing desired density for wet or dry friction application;

FIG. 4 is a process diagram illustrating another method of processing a nonwoven needlepunched textile-reinforced polymer composite material having carbide nanomaterials dispersed therein in accordance with the principles of the present invention;

FIG. 5 is a photomicrograph of a nonwoven needlepunched textile-reinforced polymer composite material without added nanomaterial;

FIG. 6 is a photomicrograph of a nonwoven needlepunched textile-reinforced polymer composite material with added nanomaterial and showing necessary porosity for effective lubrication fluid flow in a wet friction material;

FIG. 7 is a graph of the coefficient of friction for a friction material containing carbide nanomaterials in accordance with embodiments of the present invention, versus NNTRC friction material containing no nanomaterials, and;

FIG. 8 is a graph that shows the results of a standard brake dynamometer automobile brake test for a friction material constructed in accordance with a preferred embodiment of the invention.

Corresponding reference numerals indicated corresponding parts throughout the several views of the drawings.

### DETAILED DESCRIPTION

The following description of the preferred embodiments is merely exemplary in nature and is in no way intended to limit the invention, its application, or uses.

Nanomaterials have physical structures with extremely large surface areas per material particle. Nanomaterials demonstrate increased mechanical and other properties that are not indicated by their chemistry. For instance, clay/polymer nanocomposites show increased mechanical and heat distortion properties separately of their expected chemistry. These new properties are likely due to an increased exposed hard surface of nano particle and an opposing friction surface. Carbide particles of the invention include those of tungsten, silicon, titanium and the like. Carbide nanomaterials function as enhanced friction components rather than fillers

Hard particles are of known benefit in friction products, and thus specific nanomaterials such as those of carbide have been developed as a friction material according to the teachings of the present invention. More specifically, carbide nano materials have been found to be novel additions to friction materials according to the present invention. However. difficulties in dispersing carbide nanomaterials in common papermaking and molded friction products has prevented utilization of these enhancers in friction materials, whereas the present invention can produce a desired product with the enhancers dispersed advantageously at the friction surface.

Unlike powders and prior art materials, carbide nano particles are microscopic and less than 1000 nanometers in size. According to the present invention, carbide nanomaterials/particles have been found to improve friction properties using minor proportional additions and are distinctly separate, although may be used in conjunction with, those particles that are typically used to fill a friction product or part.

The carbide nanoparticles are made of carbide by various techniques including milling, grinding and screening techniques. Unlike normal powders and fibers, carbide nanomaterials have reported structures with chemically active areas in the range of approximately 0.5-100 m²/gm. Additional geometry of carbide nanomaterials include between approximately 20-500 μm in particle size.

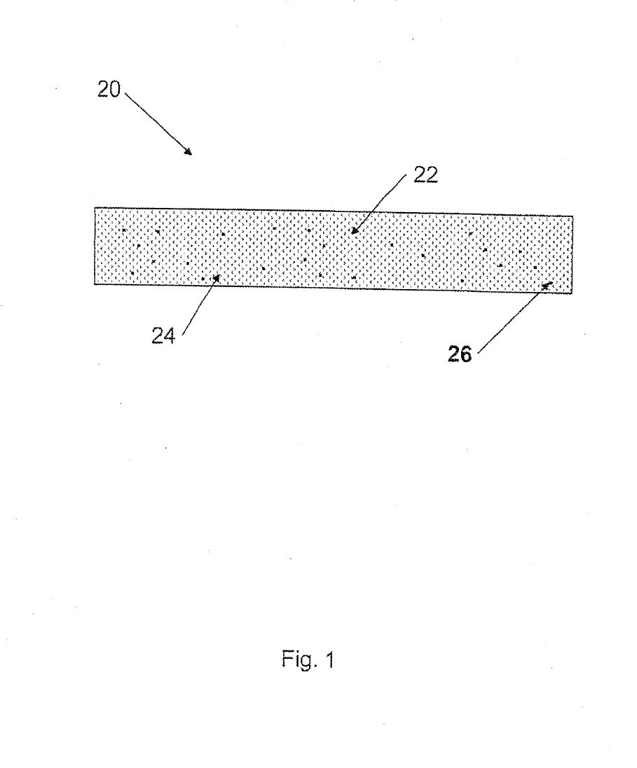

Referring now to FIG. 1, a composite friction material according to the present invention is illustrated and generally indicated by reference numeral 20. The composite friction material 20 comprises a fiber mat of staple fibers 22, a resin matrix 24 impregnated within the fiber mat 22, and a carbide nanomaterial 26 dispersed within the resin matrix 24. The carbide nanomaterial covers a portion of the friction surface of the friction material 20. (It should be understood that the FIG. 1 illustration is merely exemplary and is not to scale). Preferably, the fiber mat 22 is a nonwoven needlepunched mat of specific needlepunched density.

A needling density of approximately 1000-7000 penetrations per cubic centimeter of needlepunched fibrous structured mat provides a unique open pore array of staple fibers which cannot be achieved by papermaking, molding or other friction manufacturing methods. In the “needlepunching” step, barbed needles engage staple fibers approximately 2 to 8 cm in length and manipulate the fiber positions, interlocking and entangling them in a unique arrangement that cannot be achieved with stitching, weaving, winding, molding and other fiber orientation methods. This “needlepunching” step reorients, ligates and/or entangles the fibers, whereas “stitching” adds a continuous length fiber to a mat structure and, as a result, the present invention produces a unique fibrous structure that is not possible with stitching and other methods, such as weaving, molding, spiral winding, etc. This resulting fibrous form has been conducive to producing both wet and dry improved friction products.

This fibrous structure then provides an advantageous mechanism through which to flow liquid resin containing the nano particles and results in a homogeneous dispersion with separation between particles which best delivers the high surface energy of any particular particle to a friction surface. The staple fibers consist of chopped fibers between approximately 1 and 8 cm. in length.

The concentration of nano particles in the resulting whole composite is preferably 2-20% by weight and is mixed and suspended into the liquid resin which is then saturated into the fibrous structure mat resulting in the dispersion as shown in the Figures. The saturation of the mat in the liquid resin is performed in a bath and then compression rolled until the dispersion of particles is achieved. In the “compression” step, the composite is densified through reduction in thickness with compression rolls or between the platens of a press and at temperatures conducive to the process. An open porosity is thus achieved and adjusted to approximately 20 to 70% by volume.

This high surface energy phenomenon of the nano particles together with the high thermal capacity and hardness of tungsten and other carbide nano particles delivers a higher and more uniform coefficient of friction to the opposing friction surface [fig.] At elevated temperatures over about 150 deg C these higher coefficients decrease the tendency of the brake to fade in operation.

The carbide nanomaterial is preferably carbide and more specifically, in a weight proportion of between approximately 2% and approximately 20% by weight of the overall composite friction material 20. In addition to the carbide nanomaterial, other particles may be present. In one form, the carbide nanomaterials define a geometry comprising approximately 0.65 m²/gm of composite nano particles at the surface area. In another form, the carbide nanomaterials define a geometry comprising approximately 0.90 m²/gm of composite nano particles at the surface area.

Preferably, the resin matrix is a thermoset polymer such as polyimide, phenolic, or epoxy. However, other thermoset polymers, or alternatively thermoplastic polymers, may also be employed as the resin matrix while remaining within the scope of the present invention.

The preferred fiber mat in one form of the invention is a staple Kevlar® material, while in other forms, the fiber mat comprises other staple aramids, glass, ceramic, staple carbon or staple graphite fibers (typically between 1 and 8 cm. in length) and/or other appropriate fibers, preferably chosen for their friction properties. The fibers can be blended in various proportions and then combined with resin in fiber to resin proportions approximately from 20:80 to 80:20 and preferably 40:60 to 70:30 on a weight basis.

In another example, silicon carbide comprises the hard particles and is blended in proportions of approximately 2% to 20% by weight.

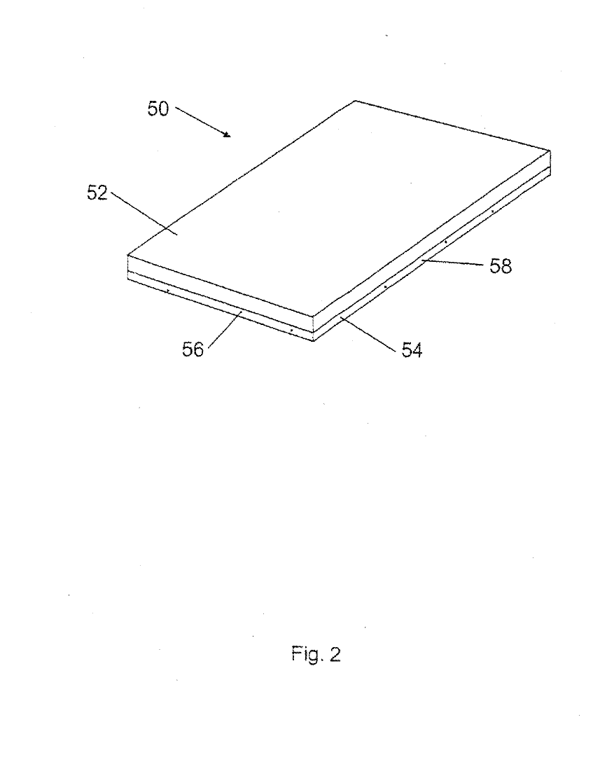

Referring now to FIG. 2, a friction product for use in a friction application is illustrated and generally indicated by reference numeral 50. The friction product 50 comprises a backing 52 and a friction element 54 attached to the backing. In accordance with the principles of the present invention, the friction element 54 comprises a nanomaterial 56 dispersed within a composite 58. Preferably, the composite 58 comprises a nonwoven needlepunched textile-reinforced fiber mat impregnated with a resin matrix as described above in connection with FIG. 1. The end application includes, by way of example, a dry brake plate, a wet brake plate, a clutch plate, a transmission friction disc, a transmission band, a brake band, a torque converter lining, a slip differential lining, or synchronizer friction element, and a brake pad or block, among others.

In one form, the backing 52 is a metal material, in another form, the backing 52 is a non-metal material in another form the backing 52 is a plastic material. Additionally, the friction element 54 is a lining or a facing, among other types of applications.

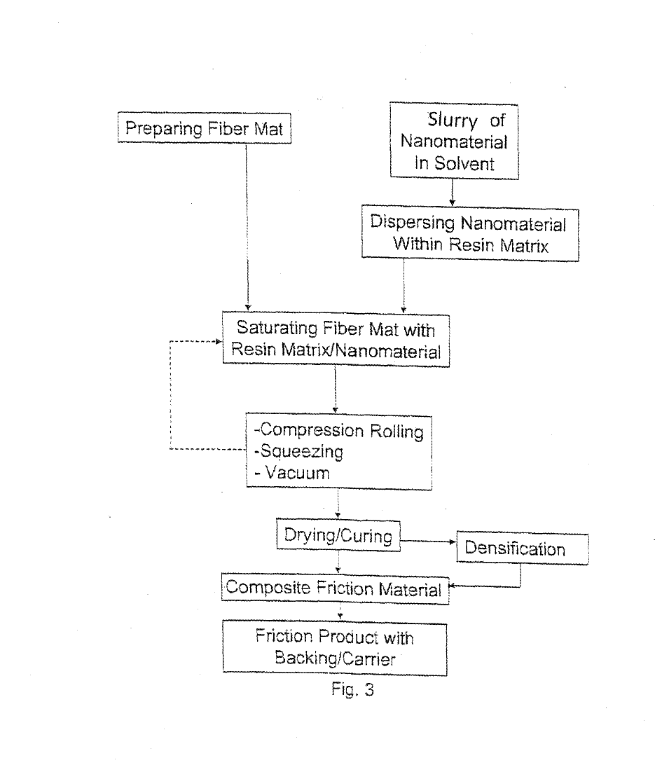

Referring to FIG. 3, a method of processing a nonwoven needlepunched textile-reinforced polymer composite material having carbide nanomaterials dispersed therein is illustrated in accordance with the principles of the present invention. Generally, carded needlepunched mats, for friction applications are first prepared. (Alternatively, but not preferably, this may be done by depositing a carbide nanomaterial onto a fiber web, batt or mat some time during the fabrication of the nonwoven material.) Liquid resin to be impregnated into the needlepunch mat is prepared by dispersing carbide nanomaterial into a solvent slurry (or slurry of resin and carbide nanomaterial) and, in turn, the slurry into the liquid resin to effect a homogeneous dispersion of separated particles, referred to hereinafter as a liquid suspension. In some instances, such a dispersion may require high-speed mixing and/or low viscosity dilutions in order to separate and disperse the particles.

The fiber mat is then saturated with the liquid suspension and is preferably compression rolled and squeezed to initiate the dispersion of carbide nanomaterial/particles into the fiber mat. To optimize dispersion, multiple passes of saturation and compression are preferably combined or alternated with application of vacuum to the fiber mat and liquid suspension. The carbide nanomaterials are dispersed through the fiber mat so that upon drying the liquid resin and obtaining a dry polymer composite, the particles populate the friction surface without themselves substantially changing the porosity of the overall composite. Subsequently, the composite material is cured and its porosity is adjusted by compression as desired for a specific end application.

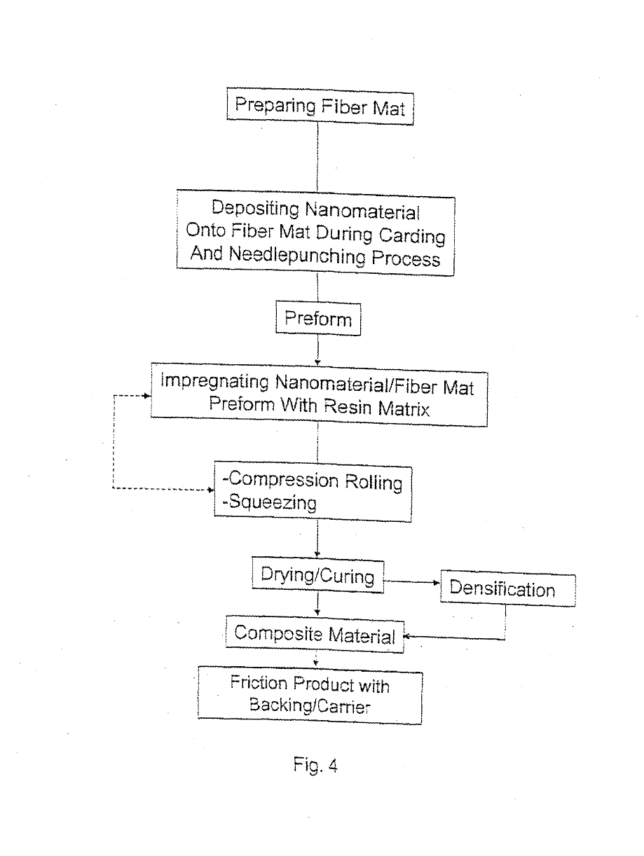

In FIG. 4, an alternate method of forming a composite material is illustrated, wherein a composite friction material preform is formed depositing a carbide nanomaterial on to a fiber mat during a process such as, by way of example, carding and needlepunching. Additionally, the preform is impregnated with a resin material to form a composite friction material. The carbide nanomaterial can be dispersed, sprinkled in dry bulk or sprayed in liquid suspension on the fiber mat, for example, during the carding and needlepunching process.

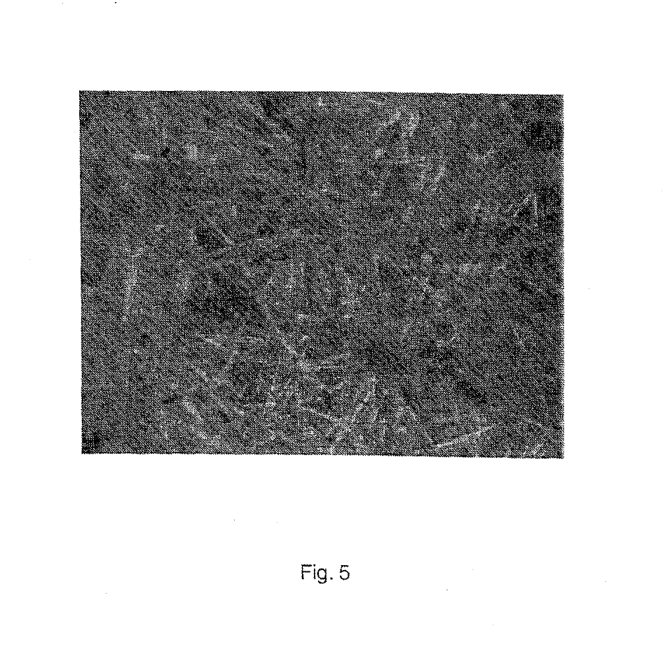

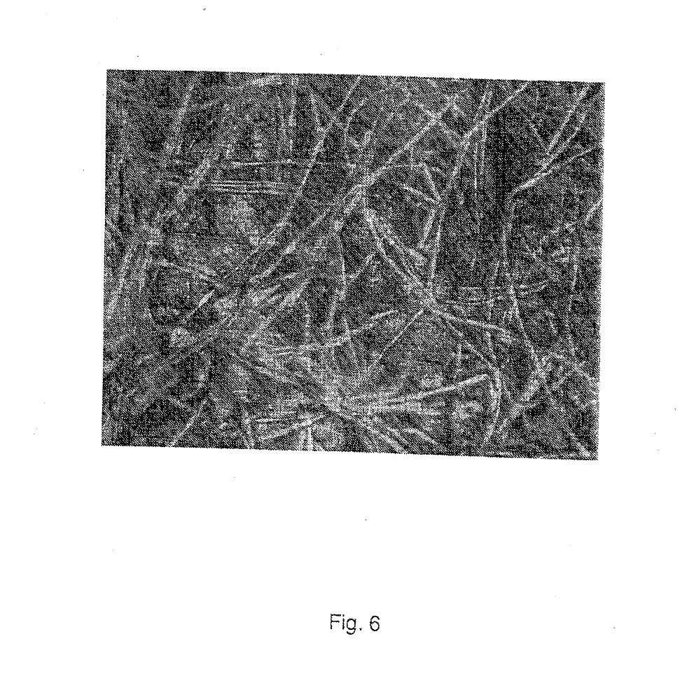

FIGS. 5 and 6 are photomicrographs of a nonwoven needlepunched textile-reinforced composite without the carbide nanomaterial (FIG. 5) and with nanomaterial (FIG. 6).

### EXAMPLE 1

A Kevlar staple fiber carded and needlepunched mat of 2500-3500 penetrations per cm³ needled density is prepared. Nano Tungsten Carbide nanomaterial (480 nano meters in size from Buffalo Tungsten) providing 0.65 m²/gm of composite nanoparticles at the friction surface in a polyimide resin liquid suspension is prepared with high speed mixing and liquid dilution. The mat is then saturated in the liquid suspension and pressed between compression rollers, and squeezed, as is know in the art. Multiple saturations and compressions alternated with vacuum impregnations wherein the mat and friction enhancing particles in the liquid are placed under vacuum until a cut cross-section of the wet mat indicates particle dispersion is followed. The composite is then dried resulting in a fiber to dry resin weight ratio of 50:50 compressed in a heated platen press to a desired porosity and then cured. The amount of carbide nanomaterial/particle addition is calculated to achieve a 3.5% by weight of the cured composite.

Porosity of the final composite is controlled to approximately 35% (+/−5%). Since the porosity is controlled by the amount of platen compression independent of the addition of the friction enhancers, porous character of the composite is retained.

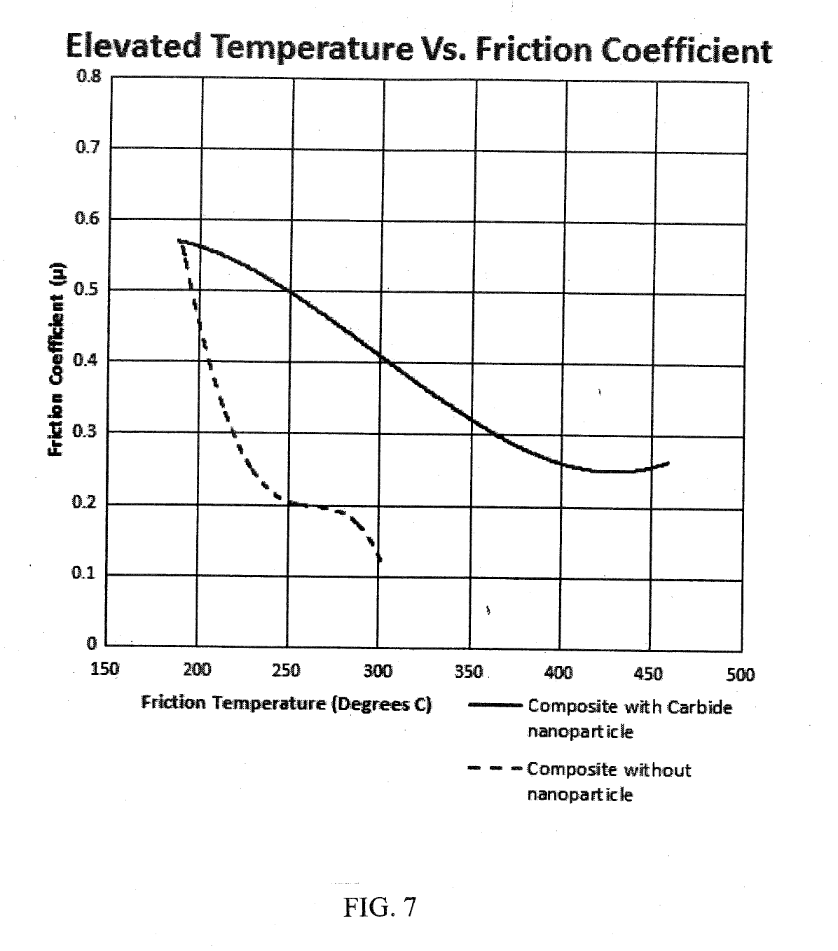

The composite is bonded to metal backing plates and fabricated into automobile brake pads and tested on a brake dynamometer. A dynamometer test that compares this friction material to a like friction composite without the nanocarbide material is the source of the data in FIG. 7. As shown in FIG. 7, one line represents the non-woven needlepunched textile-reinforced composite without friction enhancers (a Braketex product from Tribco Inc., Cleveland, Ohio.) The other line represents the non-woven needlepunched textile-reinforced composite with a 3.5% by weight of tungsten carbide nanomaterial. This line indicates an increased dynamic coefficient of friction, with increasing temperature. The sample also exhibits a lower wear rate than original equipment for the automobile application.

### EXAMPLE 2

A Kevlar/polymide composite is prepared as in Example 1 but silicon carbide nanomaterials of 50 nanometers in size with providing 0.80 m²/gm of composite nano particles at the friction surface area are used in place of tungsten carbide in a proportion of 6% by weight.

The 6% silicon carbide sample brake pads were installed in an automobile brake and resulted in decreased fade and substantial elimination of visible brake dust.

It is apparent that the four brake pads with nano enhancers (Examples 1-2 showed substantially higher coefficients of friction at elevated temperatures than the standard without enhancers. It is also apparent that the enhancers reduced the difference between dynamic coefficients of friction between those at the beginning of friction engagement less and before the end of the engagement at which point the friction interface is at its maximum temperature. This would result in the improvement of more uniform pressure being applied during the stop. Generally increasing temperatures with proportions of increasing enhancers indicate more heat energy being conducted to the opposing surfaces which dissipate energy away from the mechanisms. This improvement would tend to degrade the composites less. As seen in FIGS. 5 and 6, the materials also retain their porosity beside their enhancer additions. The enhancers do not significantly affect the open porosity character of the composite. These results would not be expected by similar additions of fillers, powders or any other additives to the fiber/polymer composites.

Together with additional tests it is indicated that friction enhancing particle additions below about 2% by weight of the composite or above about 20% by weight did not exhibit further improvements beyond those within that range of volume proportions.

The friction materials of these examples can be applied as friction linings or facings to appropriate metal backings for use as brake pads, clutch plates, automatic transmission friction discs, transmission or brake bands, torque converters, slip differential friction products, and the like. Alternatively, non-metal backings are attached or no backings wherein the friction materials employed as free-floating devices are used for friction products.

It is apparent that improved friction materials can be obtained when employing carbide nano materials in proportions of approximately 2% by weight to 20% by weight of nonwoven needlepunched textile-reinforced polymer matrix friction composites.

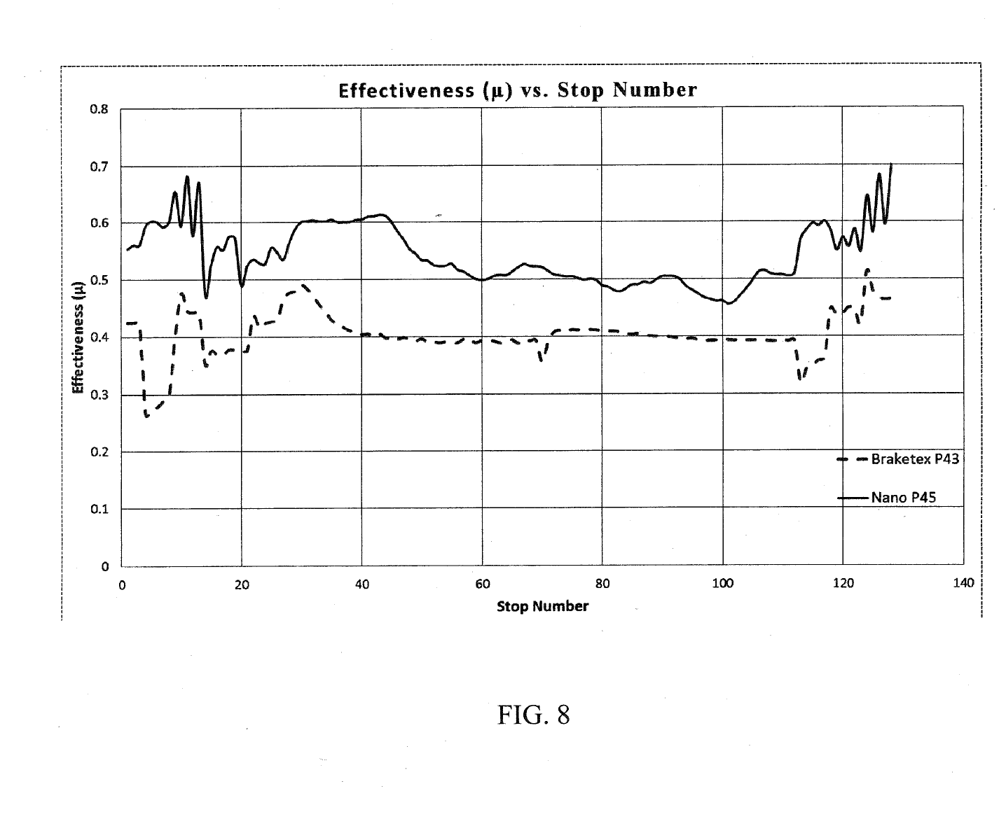

FIG. 8 is a graph that shows the results of a standard brake dynamometer test following the SAE J-2430 automobile brake test procedure which was modified for accelerated burnish. This test operated up to and exceeded 300 deg C in surface temperatures. As such, it precluded the use of low temperature resistant fibers, for example, cellulose and those of low, approximately 250 deg C, heat resistance. The solid line shows the brake performance of a “Nano P-45” sample, which is a sample made according to the present invention. The dashed line shows the performance of a standard Braketex P43 material which is a friction material constructed in accordance with U.S. Pat. No. 5,646,076 and which is hereby incorporated by reference. The term “effectiveness” shown on the graph, is the dynamic coefficient of friction and the term “stops” refers to the number of brake stops conducted during the test. The friction material constructed in accordance with the invention exhibits approximately 0.046 to 0.70 dynamic coefficients of friction while the material constructed in accordance with U.S. Pat. No. 5,646,076 exhibits dynamic coefficients of friction of 0.26 to 0.51. The sample constructed in accordance with a preferred embodiment of the invention shows a braking improvement of greater than ⅓.

It should be stated here, that with the present invention, the disclosed needlepunched densities provide a material with adequate porosity for fluid flow in a wet friction application, while providing adequate porosity for the impregnation of nano particles.

The inventors believe that due to the unique presence of a large number of these carbide nanomaterials produce improvements in nonwoven needlepunched textile-reinforced composites without substantially affecting their porous structure or the character of the material as a whole and substantially improve the result. Among other things, it may be the increased thermal conductivity along the length and micro structure of the fibers and tubes compared to materials used as fillers, that conducts heat to surrounding parts, and results in higher coefficients of friction at elevated temperatures. The carbide nanomaterial introduces asperities of increased hardness and heat resistance at the friction surface, and possibly accounts for their enhancing effect.

By eliminating the preponderance of cellulose fibers inherent in friction paper type materials and substituting those of the invention, chosen for heat and energy resistance and needlepunched to the specified needle density, deficiency of fluid flow is overcome. In addition, it is inherent to the carded and needlepunched fibrous form of the invention that the pores formed are interconnected and not closed as is the case with cellulose based friction paper composites.

The inventors also believe that the disclosed composite friction materials are more environmentally friendly as compared to prior art materials. When used as a brake material, the high specific gravity of the carbide nanomaterial, (for example 3-15 gm/cm³) tends to substantially reduce air borne brake dust.

Unlike the bulk of the fiber and polymer matrix composite, the carbide nanoparticles have an extremely high surface area per mass of material. In addition the particles have a high hardness value relative to the balance of composite. These factors result in higher coefficients of friction and increased heat resistance which reduces the tendency of an applied brake to “fade” in its effectiveness as it stops.

The description of the invention is merely exemplary in nature and, thus, variations that do not depart from the substance of the invention are intended to be within the scope of the invention. Such variations are not to be regarded as a departure from the spirit and scope of the invention.

Having described the invention, we claim:

1. An improved composite friction material for use in friction applications comprising a nonwoven needlepunched fiber mat of staple fibers, said fiber mat of staple fibers being needlepunched to a density of 2000-7000 penetrations per cm³, a resin matrix impregnated in the fiber mat; and a carbide nanomaterial dispersed within the composite, the carbide nanomaterial selected from the group consisting of tungsten, titanium and silicon and comprising between approximately 2 and 20% of the composite material by weight such that said composite friction material has increased dynamic coefficient of friction and increased fade resistance.

2. The improved composite friction material of claim 1 wherein said fiber mat of staple fibers is needlepunched to a density of 2500-3500 penetrations per cm³.

3. The improved composite friction material of claim 1 wherein said staple fibers are selected from a group comprising aramid, glass, ceramic and carbon fibers.

4. A friction product for use in a friction application comprising a backing and an improved composite friction material according to claim 1.

5. The friction product according to claim 4 wherein the friction product is selected from the group consisting of a brake plate, a clutch plate, a transmission band, a brake band, a torque converter lining, a slip differential or synchronizer friction element and a brake pad or block and the backing is metal.

6. The friction product according to claim 5, wherein the friction element is a lining, facing or unattached member.

7. A composite friction material comprising: a carded and needlepunched fiber mat of staple fibers selected from a group comprising aramid, glass, ceramic and carbon fibers; a resin matrix impregnated into the needlepunched fiber mat; and a carbide nanomaterial selected from a group consisting of tungsten, silicon and titanium and dispersed within the composite in an amount between approximately 2 and 20% of the composite friction material, said fiber mat of staple fibers being needlepunched to a density of 2000-7000 penetrations per cm³.

8. A method of forming an improved composite friction material comprising the steps of: preparing a fiber mat, dispersing a carbide nanomaterial using a slurry of said nanomaterial in a solvent within a resin and saturating the fiber mat with resin containing the nanomaterial, drying, curing and densifying the resulting composite material and combining the composite material with a support backing.

9. The composite material of claim 7 wherein said fiber mat of staple fibers is needlepunched to a density of 2500-3500 penetrations per cm³.

10. The composite material of claim 9 wherein the composite porosity is 30%-40% by volume.
